(19) United States
(12) Patent Application Publication
(10) Pub. No.: US 2026/0034628 A1
(43) Pub. Date: Feb. 5, 2026

(54) Suction Adapter Device for a Handheld Power Tool

(71) Applicant: Robert Bosch GmbH, Stuttgart (DE)

(72) Inventors: Xiao Qiu, Weingarten (DE); Denis Pedalina, Esslingen Am Neckar (DE); Patrick Schlauch, Esslingen (DE)

(21) Appl. No.: 19/285,854

(22) Filed: Jul. 30, 2025

(30) Foreign Application Priority Data
Jul. 31, 2024 (DE) 10 2024 207 235.4

(51) Int. Cl. B23Q 11/00; B23B 45/00

(52) U.S. Cl. CPC B23Q 11/0071; B23B 45/003; B23Q 11/0046

(57) ABSTRACT

A suction adapter device for a handheld power tool, in particular a portable drill, is disclosed. The suction adapter device includes a suction head unit for direct application to a workpiece. The suction head includes (i) a tool guidance area bounding a through-hole recess for receiving and guiding a tool, (ii) a workpiece support element adjacent the tool guidance area for application to the workpiece, (iii) a main intake port to suction a main suction air flow, (iv) a suction connector for, in particular releasable, connection of a suction hose, and (v) a suction air duct extending from the main suction opening to the suction connector to guide a suction air flow and including a dust carrying section in which the suction air duct extends about the through-hole recess and is open in the direction of the through-hole recess. The suction head unit further includes a secondary intake port for suctioning a secondary suction air flow that flows into the suction air duct at one end of the dust carrying section or behind the dust carrying section.

This application claims priority under 35 U.S.C. § 119 to application no. DE 10 2024 207 235.4, filed on Jul. 31, 2024 in Germany, the disclosure of which is incorporated herein by reference in its entirety.

### BACKGROUND

A suction adapter device for a handheld power tool, in particular, a portable drill, with a suction head unit for direct application to a workpiece, which comprises a tool guidance area, which bounds a through-hole recess for receiving and guiding a tool, a workpiece support element adjacent the tool guidance area for application to the workpiece, a main intake port for intake of a main suction air flow, a suction connector to a, in particular releasable, connection of a suction hose, and a suction air duct extending from the main intake port to the suction connector for guidance of a suction air flow, which comprises a dust carrying section, in which the suction air duct extends around the through-hole recess and is open towards the through-hole recess, has already been proposed.

### SUMMARY

The disclosure proceeds from a suction adapter device for a handheld power tool, in particular, a portable drill, with a suction head unit for direct application to a workpiece, which comprises a tool guidance area, which is adjacent to a through-hole recess for receiving and guiding a tool, a workpiece support element adjacent the tool guidance area for application to the workpiece, a main intake port for intake of a main suction air flow, a suction connector to a, in particular releasable, connection of a suction hose, and a suction air duct extending from the main intake port to the suction connector for guidance of a suction air flow, which comprises a dust carrying section, in which the suction air duct extends around the through-hole recess and is open towards the through-hole recess.

It is proposed that the suction head unit comprises a secondary intake port for suctioning a secondary suction air flow, which flows into the suction air duct at one end of the dust carrying section or behind the dust carrying section. “Provided” is understood in particular as meaning specifically adapted, specifically designed and/or specifically equipped. The fact that an object is intended for a specific function should be understood in particular to mean that the object fulfills and/or executes this specific function in at least one application and/or operating mode. By the design of the suction adapter device according to the disclosure, advantageous properties regarding a suction efficiency of the suction adapter device can be enabled in a processing area in order to advantageously enable a high level of operator comfort. In particular, advantageous properties with regard to air resistance and a maintenance of the negative pressure in the suction air duct can be provided. Advantageously, the air resistance for the air flow through the main intake port may be reduced. Advantageously, the overall power when suctioning heavy dust charges may be lowered. Advantageously, by reducing the maximum negative pressure, the use time for vacuum cleaners can be extended until the low air flow warning (<=20 m/s at the hose end) is activated.

Preferably, the suction adapter device is provided to remove dust, chips, and/or particulate matter from a machining area of the handheld power tool. Preferably, the suction adapter device is provided to feed dust, chips, and/or particulate matter out of a machining area of the handheld power tool of an external suction machine, in particular a vacuum cleaner, in particular a vacuum hose of the vacuum cleaner. Preferably, the suction adapter device is provided to guide a suction air flow of an external suction machine, in particular a vacuum cleaner, into a machining area of the handheld power tool. Additionally, the suction adapter device is in particular provided to partially bound an extraction area and/or a machining surface on a workpiece to be machined with the handheld power tool. Preferably, the suction adapter device is provided to establish a releasable connection with an external suction machine, in particular a vacuum cleaner. Preferably, the suction adapter device is disposable on the handheld power tool, in particular, in a removable manner. Preferably, the suction adapter device is releasably attachable to the handheld power tool. Preferably, the suction adapter device is releasably attachable to a tool for the handheld power tool, in particular to a drill. Preferably, the suction adapter device is provided to remove dust, chips, and/or particulate matter generated in the machining area by machining of a workpiece and/or a machining surface using the handheld power tool, in particular by the tool disposable on the handheld power tool. Preferably, the handheld power tool is designed as a portable drill. Further, all other handheld power tools that appear to be useful to those skilled in the art are contemplated. Preferably, the suction adapter device is formed at least in part, preferably at least to a large extent, by the suction head unit. The expression “at least to a large extent” should in particular be understood here to mean at least 55%, advantageously at least 65%, preferably at least 75%, particularly preferably at least 85% and particularly advantageously at least 95%. Preferably, a tool that may be disposed on the handheld power tool, particularly a tool that may be disposed in a tool holder of the handheld power tool, extends through the suction head unit of the suction adapter device.

Preferably, the suction head unit comprises a tool guidance area that limits a through-hole recess for receiving and guiding the tool disposable on the handheld power tool. Preferably, the tool guidance area is configured to at least partially transfer a movement of the handheld power tool to the suction adapter device. Preferably, the tool guidance area serves in particular to provide an, in particular indirect, disposal of the suction head unit on the handheld power tool. The suction head unit is aligned via the tool guidance area, in particular relative to a machining axis of the tool. Preferably, the tool guidance area defines a tool guidance axis that extends at least essentially parallel to a direction extending to a longitudinal extension axis of the through-hole recess. “Essentially parallel” is to be understood here in particular to mean an orientation of a direction relative to a reference direction, in particular in a plane, wherein the direction has a deviation relative to the reference direction that is in particular less than 8°, advantageously less than 5° and particularly advantageously less than 2°. Preferably, a longitudinal extension axis of the tool is aligned at least essentially parallel to the tool guidance axis. Preferably, a longitudinal extension axis of the tool is coincident with the tool guidance axis in the through-hole recess. Preferably, when the suction adapter device is connected to the handheld power tool, the tool disposable in the handheld power tool is disposed in the tool guidance area. Preferably, the tool disposable on the handheld power tool, particularly the tool disposable in a tool holder of the handheld power tool, is disposed in the through-hole recess when the suction adapter device is connected with the handheld power tool. Preferably, the tool which can be disposed on the handheld power tool, in particular the tool which can be disposed in a tool holder of the handheld power tool, extends through the through-hole recess. Preferably, the suction head unit in particular encloses the tool disposable on the handheld power tool in at least two spatial directions. Preferably, the suction head unit is provided to enclose the tool disposable on the handheld power tool, in particular in a plane perpendicular to the tool guidance axis, at least in part, in particular entirely.

Preferably, the suction head unit comprises a suction connector. Preferably, the suction connector is provided to establish a releasable connection with an external suction machine, in particular a vacuum cleaner. Preferably, the suction connector is provided to make available a releasable coupling location for an external suction machine suction hose on the suction head unit. Preferably, a suction hose of the external suction machine is releasably attachable to the suction connector. Preferably, the suction connector is configured as a quick-release, such as that known under the product name Bosch Click & Clean System. Alternatively or additionally, the coupling point is configured as a tapered universal interface. Preferably, a longitudinal extension axis of the suction connector is aligned at least essentially perpendicular to the tool guidance axis. In particular, it is contemplated that a longitudinal extension axis of the suction connector includes an angle with the tool guidance axis, in particular an angle less than 90°, preferably less than 60°, particularly preferably less than 45°. The expression “essentially perpendicular” is intended in particular to define an orientation of a direction relative to a reference direction, wherein the direction and the reference direction, in particular viewed in a projection plane, enclose an angle of 90° and the angle has a maximum deviation of in particular less than 8°, advantageously less than 5° and particularly advantageously less than 2°.

The suction head unit comprises the workpiece support element. Preferably, the workpiece support element has a main extension plane which is at least essentially perpendicular to a tool guidance axis. Preferably, the workpiece support element is configured to form a connecting surface with a workpiece and/or a machining surface. Preferably, the main extension plane of the workpiece support element is aligned at least essentially parallel to the workpiece and/or the machining surface when applied to a workpiece and/or a machining surface.

Preferably, the workpiece support element at least partially surrounds the through-hole recess.

Preferably, the suction head unit comprises a main intake port, in particular the aforementioned one. Preferably, the main intake port is configured to provide access for a main suction air flow into the suction head unit. Preferably, the main intake port is formed in an outer wall of the suction head unit. Preferably, the main intake port has a main extension plane which is aligned at least essentially parallel to the tool guidance axis. In particular, in a further exemplary embodiment, it is contemplated that the main extension plane of the main intake port is aligned at least essentially perpendicular to the tool guidance axis. Further, and/or additionally, it is contemplated that the main extension plane of the main intake port includes an angle with the tool guidance axis, in particular an angle less than 90°, preferably less than 60°, particularly preferably less than 45°. A “main extension plane” of a structural unit should be understood to be a plane which is parallel to a largest side surface of a smallest notional cuboid which just completely encloses the structural unit, and in particular extends through the midpoint of the cuboid. Further, all configurations of the main intake port that seem useful to a person skilled in the art are contemplated. Preferably, the main intake port is formed on a side of the suction head unit facing away from the suction connector. Preferably, the main intake port is disposed at least essentially 180° offset from the suction connector about the tool guidance axis.

Preferably, the suction air duct connects the main intake port to the suction connector. Preferably, a main suction air flow in the suction air duct runs from the main intake port to the suction connector. Preferably, the main suction air flow is generated by an external suction machine via the suction connector. Preferably, the suction air duct is configured at least partially open. Preferably, the suction air duct is configured at least partially open at least in a direction extending at least essentially perpendicular to the tool guidance axis, in particular towards the side facing the workpiece support element. Preferably, a vacuum is generated between the workpiece and/or the machining surface and the workpiece support element by way of the main suction air flow guided through the suction air duct. Preferably, the vacuum is provided to hold the suction head unit on a tool and/or a machining surface. Preferably, the vacuum is configured to remove dust, chips, and/or particulate matter generated in the machining area by machining a workpiece and/or a machining surface by the handheld power tool, in particular by the tool disposable on the handheld power tool, via the suction connector. Preferably, the suction air duct comprises a dust carrying section. Preferably, the dust carrying section is disposed near the through-hole recess. Preferably, the dust carrying section is disposed at least substantially parallel to the workpiece and/or the machining surface. Preferably, the dust carrying section is provided to remove dust, chips, and/or particulate matter generated in the machining area by machining a workpiece and/or a machining surface by the handheld power tool, in particular by the tool disposable on the handheld power tool, at least to a majority, preferably entirely.

The suction head unit comprises the secondary intake port. Preferably, the secondary intake port is provided to reduce the air resistance of the main intake port. Preferably, the secondary intake port is provided to provide access for a secondary suction air flow into the suction head unit. Preferably, the secondary intake port is configured to remove the suction air flow flowing through the suction air duct towards the suction connector. Preferably, the secondary intake port is disposed in an outer wall of the suction head unit. The secondary intake port preferably comprises a main extension plane. Preferably, the main extension plane of the secondary intake port includes an angle with the tool guidance axis, in particular an angle less than 90°, preferably less than 60°, particularly preferably less than 45°. Alternatively and/or additionally, it is contemplated that the main extension plane of the secondary intake port is aligned at least essentially perpendicular or parallel to the tool guidance axis. Preferably, the secondary intake port is formed between the dust carrying section and the suction connector in the suction air duct. Alternatively, it is contemplated that the secondary intake port may be fluidly formed at one end of the dust carrying section. Preferably, the suction head unit comprises a protection element close to the secondary intake port. Preferably, the protection element is disposed in the suction air duct. Preferably, the protection element is configured to prevent dust from escaping through the secondary intake port. Preferably, the protection element is integrally formed, in particular as one piece, with the suction head unit. For example, in an exemplary embodiment, the protection element is configured as an overhang over the secondary intake port, wherein the protection element at least partially directs a main suction air flow away from the secondary intake port. Preferably, the protection element extends from one side of the secondary intake port in the flow towards the suction connector. The protection element has a main extension plane, which extends in the flow towards the suction connector. Preferably, the protection element is disposed in the flow at least in part between the main suction air flow and the secondary suction air flow. Preferably, the protection element at least partially shields the secondary intake port, preferably at least to a large extent from a main suction air flow. Preferably, the main suction air flow suctioned through the main intake port and the secondary suction air flow drawn through the secondary intake port are merged into one flow in the direction of the suction connector to form one suction air flow. Preferably, the protection element laminarly merges the main suction air flow and the secondary suction air flow, thereby advantageously reducing the formation of turbulence. Further, it is contemplated that the suction head unit may comprise at least one further secondary intake port.

Furthermore, it is proposed that the tool guidance area defines a tool guidance axis, in particular the aforementioned one, wherein the secondary intake port is disposed circumferentially about the tool guidance axis essentially offset from the main intake port. Preferably, the secondary intake port is circumferentially disposed about the tool guidance axis essentially offset from the main intake port and in the tool guidance axis. Preferably, “essentially” should be understood to mean an offset of the secondary intake port circumferentially about the tool guidance axis to the main intake port of at least 45°. Alternatively, it is contemplated that the secondary intake port is circumferentially essentially offset about the tool guidance axis to the main intake port and disposed in the tool guidance axis on a handling plane. Preferably, the secondary intake port is essentially offset from the main intake port circumferentially about the tool guidance axis in a clockwise direction. Further, it is contemplated that the suction machine will have a further secondary intake port which is circumferentially disposed about the tool guidance axis essentially offset from the main intake port and the secondary intake port. Preferably, the secondary intake port is offset between the main intake port and the suction connector. It is further proposed that the secondary intake port be disposed circumferentially about the tool guidance axis by at least 70°, preferably at least 90°, offset from the main intake port. Preferably, the secondary intake port is disposed clockwise circumferentially about the tool guidance axis by at least 70°, preferably at least 90°, offset from the main intake port. Alternatively, it is contemplated that the secondary intake port is disposed counterclockwise circumferentially about the tool guidance axis by at least 70°, preferably at least 90°, offset from the main intake port. For example, in one embodiment, the secondary intake port is disposed circumferentially offset about the tool guidance axis at a 75° angle to the main intake port. Preferably, the secondary intake port is disposed circumferentially about the tool guidance axis between 70° and 290°, preferably between 90° and 270°, offset from the main intake port. It is further contemplated that the suction head unit comprises further secondary intake ports which are disposed circumferentially about the tool guidance axis between 70° and 290°, preferably between 90° and 270° offset from the main intake port. Further, the secondary intake port and the further secondary intake ports are disposed evenly circumferentially about the tool guidance axis between 70° and 290°, preferably between 90° and 270°, offset from the main intake port. In this way, particularly advantageous properties regarding an influence on the air resistance and a maintenance of the negative pressure in the suction air duct can be provided. Advantageous properties with regard suction efficiency can be enabled, in particular.

Furthermore, it is proposed that at least 10% of a total suction air flow is suctioned via the secondary intake port. Preferably, the suction air flow is composed at least essentially of the main suction air flow and the secondary suction air flow. Preferably, at least 10% of the suction air flow is provided via the secondary suction air flow drawn through the secondary intake port. Preferably, at least 10% of the flow rate of the entire suction air flow is drawn in via the secondary intake port as the secondary suction air flow. Preferably, the suction air flow is generated, in particular completely, by the external suction machine which is connectable to the suction connector. In addition, it is contemplated that the suction air flow may comprise at least one leakage air flow which could be generated by the through-hole recess and/or other apertures. Further, any other compositions of the suction air flow that appear to be useful to those skilled in the art are contemplated. Preferably, at least 10%, preferably at least 15%, or particularly preferably at least 20%, of a total suction air flow is suctioned via the secondary intake port. Preferably, the secondary suction air flow suctioned through the secondary intake port is controlled via the geometry, particularly the cross-sectional area and/or opening area, of the secondary intake port. For example, the main intake port has 83% and the secondary intake port has 13% of the effective cross-sectional area of the entire opening cross-section of the inlets. In particular, the 4% of the effective remaining cross-sectional area is attributed to the inlets of the leakage air streams. By way of the design according to the disclosure, advantageous properties can be provided with regard to a cleaning result as well as a cleaning efficiency.

Advantageously, usage variability for a wireless vacuum cleaner can be improved.

It is further suggested that the tool guidance area defines a tool guidance axis, in particular the aforementioned one, wherein the suction air duct extends circumferentially about the tool guidance axis over an angular range of at least 180° about the tool guidance axis. Preferably, the suction air duct extends at least to a majority at least essentially perpendicular to the tool guidance axis. Preferably, the suction air duct extends circumferentially about the tool guidance axis over an angular range of at least 180°, preferably at least 200°, or particularly preferably 220° about the tool guidance axis. Alternatively or additionally, it is contemplated for the suction air duct to extend helically about the tool guidance axis, in particular over an angular range of at least 180° about the tool guidance axis. Preferably, the suction air duct is configured as at least partially open in the extension about the tool guidance axis in the direction of the tool guidance area. Preferably, the suction air duct is configured as at least partially open in the extension about the tool guidance axis in the direction of the tool. Preferably, the suction air duct is configured at least approximately as a circular or oval-shaped circular ring about the tool guidance axis. Alternatively, all other annular shapes of the suction air duct that appear to be useful to a person skilled in the art are contemplated about the tool guidance axis. By way of the design according to the disclosure, advantageous properties with regard to suction efficiency can be enabled. In particular, advantageous properties with regard to complete suction can be provided in multiple spatial directions.

Furthermore, it is proposed that the suction air duct be at least partially bounded by a workpiece in operation. Preferably, the workpiece support element rests on a workpiece in operation. Preferably, the suction air duct is at least partially bounded by a workpiece on a workpiece support element in operation. Preferably, the suction air duct has a main extension plane extending parallel to a main extension plane of the workpiece support element. Preferably, a workpiece at least partially bounds the suction air duct, preferably to a majority, perpendicular to a main extension plane of the suction air duct. Preferably, the suction air duct is at least essentially perpendicular to a tool guidance axis at least partially bounded by a part. By way of the embodiment according to the disclosure, advantageous properties with regard to the generation of a vacuum pressure, in particular to a generation of a pressure gradient, can be enabled. In particular, an advantageous extraction of dust, chips, and/or particulate matter generated in the machining area by machining a part and/or a machining surface using the handheld power tool, in particular by the tool disposable on the handheld power tool.

It is further proposed that the suction head unit comprises a housing that at least partially forms the tool guidance area and the workpiece support element. Preferably, the housing forms the tool guidance area and the workpiece support element at least to a large extent. Preferably, the housing is formed in multiple parts. Preferably, the housing is formed in two parts. Preferably, the housing at least partially forms the suction air duct. In particular, it is contemplated that the partial housing of the housing may be releasably connectable to allow for advantageous cleaning properties. The fact that at least a first element is “connected” to at least one further element should be understood in particular to mean that the first element is advantageously connected to the further element via at least one frictional joint and/or at least one positive-locking joint, for example, via a rivet and/or a catch connection and/or a groove-spring connection and/or a clamp connection and/or another process which appears useful to person skilled in the art, and/or is materially connected to the further element, for example by a welding process, an adhesive process, an injection process and/or another process which appears useful to the person skilled in the art. Preferably, the housing is formed by an injection process. Alternatively, all other manufacturing processes that appear useful for the housing to a person skilled in the art are also contemplated. Preferably, the housing consists largely of a plastic material and/or a composite material. In particular, it is contemplated that parts of the housing are made of a purely metallic material. Furthermore, all other materials that would appear sensible to a person skilled in the art are contemplated. By way of the design according to the disclosure, advantageous properties with regard to a construction of the suction head unit may be enabled. In particular, a compact and simplified suction head unit may be advantageously provided. In particular, advantageous properties with respect to user comfort may be enabled by simplified cleaning.

Furthermore, it is proposed that the main intake port and the secondary intake port be formed integrally with the housing. Preferably, the main intake port and the secondary intake port are integrable in a manufacturing process of the housing. Preferably, the housing is configured in multiple parts, in particular in two parts. Preferably, the main intake port and the secondary intake port are integrally formed on two different sub-housings. Alternatively, it is contemplated that the main intake and the secondary intake port are integrally formed with the same sub-housing. The term “as a single piece” is to be understood in particular to mean at least a materially bonded connection, for example, by a welding process, an adhesive bonding process, an injection molding process and/or another process that appears to the person skilled in the art to be reasonable, and/or advantageously formed in one piece, for example, by production from a casting and/or by production in a single-component or multi-component injection molding method and advantageously from a single blank. Advantageously, “as a single piece” should also be understood as “integrally”. The term “integrally” should be understood in particular to mean to be formed as a single piece. Preferably, this single piece is manufactured from a single blank, a mass and/or a casting, particularly preferably in an injection molding method, especially a single and/or multi-component injection molding method. By way of the design according to the disclosure, advantageous properties with regard to a construction of the suction head unit can be enabled. In particular, a compact and simplified suction head unit may be advantageously provided. Particularly advantageous properties with respect to a user comfort can be enabled by simplified cleaning.

It is further proposed that the suction head unit comprises a tool guidance element, which is at least partially pivotably supported and is provided for direct application to a tool, in particular a drill. Preferably, the tool guidance element is provided to at least partially transfer a movement of the handheld power tool to the suction adapter device. Preferably, the tool guidance element is disposed close to the tool guidance area. Preferably, the tool guidance element is at least partially disposed in the through-hole recess bounded by the tool guidance area. Preferably, the tool guidance element has a pivot axis. Preferably, the pivot axis extends at least substantially perpendicular to the tool guidance axis. The pivot axis preferably extends at least essentially parallel to the main extension plane of the workpiece support element. Preferably, the tool guidance element is at least partially pivotably mounted about the pivot axis. Preferably, the tool guidance element is pivotably mounted about the pivot axis by at least a 10° angle, preferably at least a 15° angle, or particularly preferably at least a 25° angle. Preferably, the tool guidance element is pivotally mounted about the pivot axis by a maximum angle of 50°. Preferably, the suction head unit comprises a spring element. Preferably, the spring element is provided to mount the tool guidance element with spring pre-loading. Preferably, the tool guidance element is mounted at least essentially perpendicular to a tool guidance axis in a spring pre-loaded manner. Preferably, the spring element is provided to releasably attach the tool, in particular a drill, to the tool guidance element, which may be disposed on a handheld power tool. Preferably, the tool disposable on a handheld power tool, in particular a drill, is attached to the tool guidance element via a friction-locking connection. By way of the embodiment according to the disclosure, advantageous properties with respect to a transfer of a movement of the handheld power tool by an operator to the suction adapter device may be enabled. In particular, advantageous properties with regard to user comfort may be provided by responsively aligning the suction adapter device to a movement of the handheld power tool by an operator.

In addition, the disclosure proposes a handheld power tool system having a handheld power tool, in particular a portable drill, and having an suction adapter device according to the disclosure. Preferably, the handheld power tool system comprises an external suction machine. Preferably, the handheld power tool, in particular the portable drill, comprises a power supply by way of a battery. Alternatively, it is contemplated that the handheld power tool, in particular the portable drill, comprises a plug-in power supply. Preferably, the handheld power tool, in particular the portable drill, comprises a tool holder, in particular the aforementioned one. Preferably, the handheld power tool is designed as a portable drill. Further, all other handheld power tools that appear to be useful to those skilled in the art are also contemplated. Preferably, a tool, in particular a drill, can be disposed in the tool holder. Preferably, in an operating state of the handheld power tool system, the suction adapter device is disposed close to the drill. Preferably, in an operating state, the drill extends through the suction adapter device. Preferably, in an operating state of the handheld power tool system, the external suction machine is connected to the suction adapter device. Preferably, the handheld power tool system is configured as a portable system, for example with a battery powered external suction machine and a battery powered drill. Alternatively, it is contemplated that parts of the handheld power tool system will have a network connection and thus be site-bound. Advantageous properties with regard to operator comfort may be enabled by the design of the handheld power tool system according to the disclosure. In particular, advantageous properties with respect to suction of dust, chips and/or particulate matter from a machining area of the handheld power tool, in particular the portable drill, may be enabled.

The suction adapter device according to the disclosure is not limited to the application and embodiment described above. In particular, the suction adapter device according to the disclosure may have a number of individual elements, components, and units that differs from the number specified herein in order to perform the function described herein. Additionally, regarding the ranges of values indicated in this disclosure, values lying within the limits specified hereinabove are also provided to be considered as disclosed and usable as desired.

### BRIEF DESCRIPTION OF THE DRAWINGS

Further advantages follow from the description of the drawings below. An exemplary embodiment of the disclosure is shown in the drawing. The drawing, the description, and the claims contain numerous features in combination. A person skilled in the art will appropriately also consider the features individually and combine them into additional advantageous combinations.

The figures show:

FIG. 1 a schematic illustration of a handheld power tool system having a handheld power tool, in particular a portable drill, and having an suction adapter device according to the disclosure,

FIG. 2 a schematic illustration of a suction adapter device according to the disclosure, and

FIG. 3 a schematic illustration of a sectional view of a suction adapter device according to the disclosure.

### DETAILED DESCRIPTION

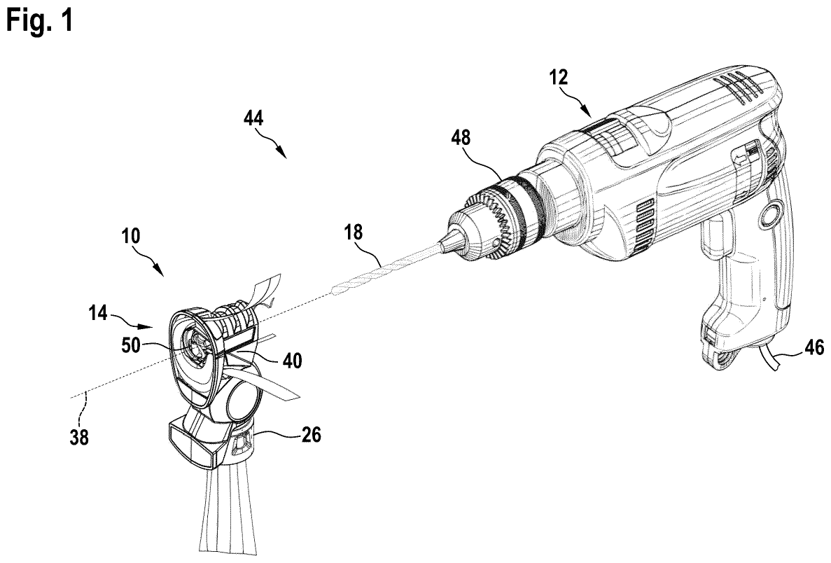

FIG. 1 shows a handheld power tool system 44 with a handheld power tool, in particular a portable drill 12, and with a suction adapter device 10. The handheld power tool, in particular the portable drill 12, comprises a plug-in power supply 46. However, it would also be contemplated that the handheld power tool, in particular the portable drill 12, comprises an accumulator. The handheld power tool, in particular the portable drill, 12 comprises a tool holder 48. A tool 18 is disposable in the tool holder 48. The tool 18 is designed as a drill. In particular, it is contemplated that the handheld power tool system 44 may comprise an external suction unit. The external suction unit comprises a suction hose. The suction hose is connectable to a suction connector 26 of the suction adapter device 10 and is provided to establish a connection between the suction adapter device 10 and the external suction unit. Further, it is contemplated that the external suction unit may be formed independent of a handheld power tool system 44. The handheld power tool, in particular the drill, 12 comprises an additional handle. The additional handle is releasably connected to a housing of the handheld power tool, in particular the drill 12. The additional handle is provided to provide a further holding surface for an operator on the handheld power tool, in particular the drill 12. Further, the handheld power tool, in particular the drill, 12 comprises a mounting point that is provided to releasably attach a suction hose to the handheld power tool, in particular the drill 12. The attachment point is configured close to, preferably contacting, an additional handle. Alternatively, any other disposition of the attachment point on the handheld power tool, in particular drill, 12 that appears to be useful to a person skilled in the art is contemplated. The attachment point is provided to releasably attach the suction hose between the suction adapter device 10 and the external suction unit on the handheld power tool, in particular the drill, 12, to advantageously influence a position and/or disposition of the suction hose.

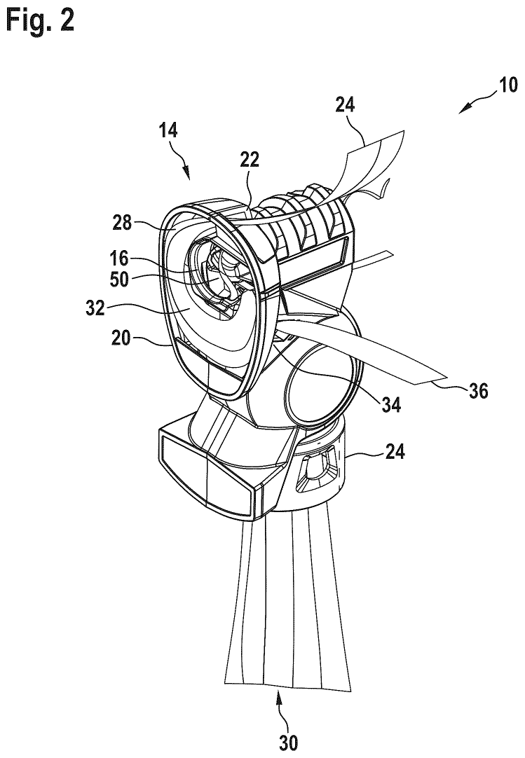

In an operating state of the handheld power tool system 44, an external suction machine is connected to the suction adapter device 10. The handheld power tool system 44 is configured as a portable system, for example, with a battery powered external suction machine and a battery powered handheld power tool, in particular a portable drill 12. Alternatively, it is contemplated that parts of the handheld power tool system 44 will have a network connection and thus be site-bound. The suction adapter device 10 is configured for a handheld power tool 12, preferably a drill 12. The suction adapter device 10 is provided to remove dust, chips, and/or particulate matter from a machining area of the handheld power tool 12. Additionally, the suction adapter device 10 is provided to limit an extraction area on a workpiece and/or a machining surface to be machined with the handheld power tool 12. The suction adapter device 10 is provided to establish a releasable connection with an external suction machine, in particular a vacuum cleaner. The suction adapter device 10 is removably disposable on the handheld power tool 12. The suction adapter device 10 is releasably attachable to the handheld power tool 12. The suction adapter device 10 is provided to remove dust, chips, and/or particulate matter generated in the machining area by machining a part and/or a machining surface using the handheld power tool 12, in particular by the tool 18 disposable on the handheld power tool 12. In an operating state of the handheld power tool system 44, the suction adapter device 10 is disposed close to the drill. The drill extends through the suction adapter device 10 in an operating state. The suction adapter device 10 is formed at least in part, preferably at least to a large extent, by a suction head unit 14 (see FIG. 2). The tool 18, which may be disposed on the handheld power tool 12, in particular a tool 18, disposable in the tool holder 48 of the handheld power tool 12 extends through the suction head unit 14 of the suction adapter device 10. The suction head unit 14 comprises a housing 40. The housing 40 is formed in multiple parts. Preferably, the housing 40 is formed in two parts. The sub-housings of the housing 40 are releasably connectable. The housing 40 is formed by an injection process. The housing 40 consists largely of a plastic material and/or a composite material. In particular, it is contemplated that parts of the housing 40 are made of a purely metallic material.

The vacuum head assembly 14 comprises a tool guidance area 16 that bounds a through-hole recess 50 to receive and guide the tool 18 disposable on the handheld power tool 12. The tool guidance area 16 is configured to at least partially transfer a movement of the handheld power tool 12 to the suction adapter device 10. The tool guidance area 16 defines a tool guidance axis 38 that extends at least essentially parallel to a direction extending to a longitudinal extension axis of the through-hole recess 50. A longitudinal extension axis of the tool 18 is disposable coincident with the tool guidance axis 38 in the through-hole recess 50. When the suction adapter device 10 is connected to the handheld power tool 12, the tool 18 disposable in the handheld power tool 12 is disposed in the tool guidance area 16. tool 18 disposable on the handheld power tool 12, in particular the tool 18 disposable in the tool holder 48 of the handheld power tool 12 is disposed in the through-hole recess 50 when the suction adapter device 10 is connected to the handheld power tool 12. The tool 18 disposable on the handheld power tool 12, in particular the tool 18 disposable in the tool holder 48 of the handheld power tool 12 extends through the through-hole recess 50. The vacuum head unit 14 encloses the tool 18 disposable on the handheld power tool 12 in at least two spatial directions (see FIG. 2).

The suction head unit 14 comprises a workpiece support element 20 adjacent the tool guidance area 16 for application to the workpiece.

The workpiece support element 20 has a main extension plane which is at least essentially perpendicular to the tool guidance axis 38. The workpiece support element 20 is configured to form a connecting surface with a workpiece and/or a machining surface. The main extension plane of the workpiece support element 20 is aligned at least essentially parallel to the workpiece and/or the machining surface when it is applied to a workpiece and/or a machining surface. The workpiece support element 20 at least partially surrounds the through-hole recess 50. The housing 40 at least partially forms the tool guidance area 16 and the workpiece support element 20 (see FIG. 2).

The suction head unit 14 comprises the suction connector 26 for, in particular, releasable attachment of a suction hose. The suction connector 26 is provided to establish a releasable connection with an external suction machine, in particular a vacuum cleaner. The suction connector 26 is provided to provide a releasable coupling point for a suction hose of the external suction machine on the suction head unit 14. The suction hose of the external suction machine is releasably attachable to the suction connector 26. The suction connector 26 is configured as a quick-release, such as that known under the product name Bosch Click & Clean System.

Alternatively or additionally, the coupling point is configured as a tapered universal interface. A longitudinal extension axis of the suction connector header 26 is aligned at least essentially perpendicular to the tool guidance axis 38. The suction connector 26 is preferably pivotally mounted on the housing 40.

The suction head unit 14 comprises a main intake port 22. The main intake port 22 is configured to provide access for a main suction air flow 24 into the suction head unit 14. The main intake port 22 is formed in an outer wall of the suction head unit 14. The main intake port 22 has a main extension plane. The main extension plane of the main intake port 22 is aligned at least essentially parallel to the tool guidance axis 38. In particular, it is contemplated in a further exemplary embodiment that the main extension plane of the main intake port 22 is aligned at least essentially perpendicular to the tool guidance axis 38. Further, and/or additionally, it is contemplated that the main extension plane of the main intake port 22 includes an angle with the tool guidance axis 38, in particular an angle less than 90°, preferably less than 60°, particularly preferably less than 45°. The main intake port 22 is formed on a side of the suction head unit 14 facing away from the suction connector 26. The main intake port 22 is disposed at least essentially 180° offset from the suction connector 26 about the tool guidance axis 38 (see FIG. 2).

The suction head unit 14 comprises a suction air duct 28 extending from the main intake port 22 to the suction connector 26, to guide a suction air flow 30. The suction air duct 28 connects the main intake port 22 to the suction connector 26. A main suction air flow 24 runs in the suction air duct 28 from the main intake port 22 to the suction connector 26. The main suction air flow 24 is generated by an external suction machine via the suction connector 26. The suction air duct 28 is configured at least partially open. The suction air duct 28 is configured at least partially open at least in a direction that extends at least essentially perpendicular to the tool guidance axis 38, in particular to the workpiece support element 20. By way of the main suction air flow 24 guided through the suction air duct 28, a vacuum pressure is generated between the workpiece or machining surface and the workpiece support element 20. The vacuum is provided to hold the suction head unit 14 on a tool 18 and/or a machining surface. The vacuum is configured to remove dust, chips, and/or particulate matter generated in the machining area by machining a workpiece and/or a machining surface by the handheld power tool 12, in particular by the tool 18 disposable on the handheld power too 121, via the suction connector 26. The suction air duct 28 comprises a dust carrying section 32. The dust carrying section 32 is disposed close by the through-hole recess 50. The dust carrying section 32 is disposed at least substantially parallel to the workpiece and/or the machining surface. The dust carrying section 32 is provided to remove at least a majority of the dust, chips, and/or particles generated in the machining area by machining a part and/or a machining surface using the handheld power tool 12, in particular by the tool 18 which can be disposed on the handheld power tool 12, at least to a majority, preferably entirely. The housing 40 at least partially forms the suction air duct 28. The suction air duct 28 is at least partially bounded by a part in operation. In operation, the workpiece support element 20 rests on a part. In operation, the suction air duct 28 is at least partially limited on a workpiece support element 20 by a workpiece. A workpiece at least partially limits the suction air duct 28, preferably primarily, at least essentially parallel to a main extension plane of the workpiece support element 20. The suction air duct 28 is at least partially limited by the workpiece in the direction of the workpiece support element 20, preferably primarily. The suction air duct 28 is at least essentially perpendicular to a tool guidance axis 38 at least partially bounded by a workpiece (see FIG. 2).

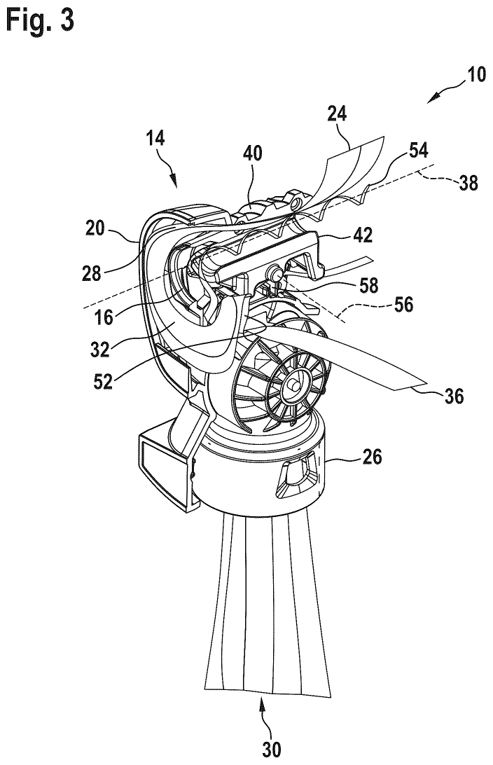

The suction head unit 14 comprises a secondary intake port 34 for suctioning a secondary suction air flow 36, which opens at one end of the dust carrying section 32 or behind the dust carrying section 32 into the suction air duct 28. The secondary intake port 34 is provided to reduce the air resistance of the main intake port 22. The secondary intake port 34 is provided to provide access for a secondary suction air flow 36 into the suction head unit 14. The secondary intake port 34 is configured to remove the suction air flow 30 flowing through the suction air duct 28 towards the suction connector 26. The secondary intake port 34 is disposed in an outer wall of the suction head unit 14. The secondary intake port 34 comprises a main extension plane. The main extension plane of the secondary intake port 34 includes an angle with the tool guidance axis 38, in particular an angle less than 90°, preferably less than 60°, particularly preferably less than 45°. Alternatively and/or additionally, it is contemplated that the main extension plane of the secondary intake port 34 may be aligned at least essentially perpendicular or parallel to the tool guidance axis 38. The secondary intake port 34 is formed between the dust carrying section 32 and the suction connector 26 in the suction air duct 28. Alternatively, it is contemplated that the secondary intake port 34 may be fluidly formed at one end of the dust carrying section 32. The suction head unit 14 comprises a protection element 52 close to the secondary intake port 34. The protection element 52 is disposed in the suction air duct 28. The protection element 52 is configured to prevent dust from escaping through the secondary intake port 34. The protection element 52 is integrally formed, in particular as one piece, with the suction head unit 14. For example, in an exemplary embodiment, the protection element 52 is configured as an overhang over the secondary intake port 34, wherein the protection element 52 at least partially directs a main suction air flow 24 away from the secondary intake port 34. The protection element 52 extends from a side of the secondary intake port 34 in the flow towards the suction connector 26. The protection element 52 has a main extension plane which extends in the flow towards the suction connector 26. The protection element 52 is disposed in the flow at least in part between the main suction air flow 24 and the secondary suction air flow 36. The protection element 52 at least partially shields the secondary intake port 34, preferably at least to a large extent from a main suction airflow 24. The main suction air flow 24 suctioned through the main intake port 22 and the secondary suction air flow 36 drawn through the secondary intake port 34 are merged into one flow in the direction of the suction connector 26 to form one suction air flow 30. The protection element 52 laminarly merges the main suction air flow 24 and the secondary suction air flow 36, thereby advantageously reducing the formation of turbulence (see FIG. 3). The main intake port 22 and the secondary intake port 34 are formed integrally with the housing 40. The main suction port 22 and the secondary intake port 34 are integrable in a manufacturing process of the housing 40. The housing 40 is formed in multiple parts, in two parts. The main intake port 22 and the secondary intake port 34 are integrally formed on two different sub-housings. Alternatively, it is contemplated that the main intake port 22 and the secondary intake port 34 are integrally formed with the same sub-housing.

At least 10% of a total suction air flow 30 is suctioned via the secondary intake port 34. The suction air flow 30 is comprised at least substantially of the main suction air flow 24 and the secondary suction air flow 36. At least 10% of the suction air flow 30 is provided via the secondary suction air flow 36 drawn in through the secondary intake port 34. At least 10% of the flow rate of the entire suction air flow 30 is drawn through the secondary intake port 34 as the secondary suction air flow 36. The suction air flow 30 is generated, in particular completely, by the external suction machine which is connectable to the suction connector 26. The suction airflow 30 additionally comprises at least one leakage airflow 54 generated by the through-hole recess 50 and/or other apertures. The leakage air flow 54 is fed at least primarily into the suction air flow 30 in a dust carrying section 32. The leakage air flow 54 is influenced by the vacuum pressure and/or a movement of the tool 18. The leakage air flow 54 is independent of a secondary suction air flow 36. The secondary suction air flow 36 drawn through the secondary intake port 34 is controlled via geometry, particularly the cross-sectional area and/or opening area, of the secondary intake port 34. For example, the main intake port 22 has 83% and the secondary intake port 34 has 13% of the effective cross-sectional area of the entire opening cross-section of the inlets. In particular, the 4% of the effective remaining cross-sectional area is attributed to the inlets of the leakage air flows 54, for example, via the through-hole recess 50 (see FIGS. 2 and 3).

The secondary intake port 34 is disposed circumferentially about the tool guidance axis 38 essentially offset from the main intake port 22. The secondary intake port 34 is essentially offset circumferentially about the tool guidance axis 38 towards the main intake port 22 and disposed on a circumferential plane in the tool guidance axis 38. The secondary intake port 34 is offset circumferentially about the tool guidance axis 38 essentially clockwise from the main intake port 22. The secondary intake port 34 is disposed offset between the main intake port 22 and the suction connector 26. The secondary intake port 34 is disposed circumferentially about the tool guidance axis 38 by at least 70°, preferably at least 90°, offset from the main intake port 22. Alternatively, it is contemplated that the secondary intake port 34 is disposed counterclockwise circumferentially about the tool guidance axis 38 by at least 70°, preferably at least 90°, offset from the main intake port 22. For example, in one embodiment, the secondary intake port 34 is disposed circumferentially offset about the tool guidance axis 38 at a 75° angle to the main intake port 22. The secondary intake port 34 is disposed circumferentially about the tool guidance axis 38 between 70° and 290°, preferably between 90° and 270°, offset from the main intake port 22.

The suction air duct 28 extends circumferentially about the tool guidance axis 38 over an angular range of at least 180° about the tool guidance axis 38. The suction air duct 28 extends at least to a majority at least essentially perpendicular to the tool guidance axis 38. Alternatively or additionally, it is contemplated that the suction air duct 28 may extend helically around the tool guidance axis 38, in particular over an angular range of at least 180° around the tool guidance axis 38. The suction air duct 28 is configured at least partially open in the extension about the tool guidance axis 38 in the direction of the tool guidance area 16. The suction air duct 28 is configured at least partially open in the extension about the tool guidance axis 38 in the direction of the tool 18. The suction air duct 28 is configured at least approximately as a circular or oval-shaped circular ring about the tool guidance axis 38 (see FIG. 2).

The suction head unit 14 comprises a tool guidance element 42, which is at least partially pivotably supported and is provided for direct application to a tool 18, in particular a drill. The tool guidance element 42 is provided to at least partially transfer a movement of the handheld power tool 12 to the suction adapter device 10. The tool guidance element 42 is disposed close to the tool guidance area 16. The tool guidance element 42 is at least partially disposed in the through-hole recess 50 bounded by the tool guidance area 16. The tool guidance element 20 has a pivot axis 56. The pivot axis 56 extends at least essentially perpendicular to the tool guidance axis 38. The swivel axis 56 extends at least essentially parallel to the main extension plane of the workpiece support element 20. The tool guidance element 42 is at least partially pivotably supported about the pivot axis 56. The tool guidance element 42 is pivotally supported about the pivot axis 56 by at least a 10° angle, preferably at least a 15° angle, or particularly preferably at least a 25° angle. The suction head unit 14 comprises a spring element 58. The spring element 58 is provided to mount the tool guidance element 42 with spring pre-loading. The tool guidance element 42 is mounted with spring pre-loading at least essentially perpendicular to a tool guidance axis 38. The spring element 58 is provided to releasably attach the tool 18 disposable on a handheld power tool 12, in particular a drill, to the tool guidance element 42. The tool 18 disposable on a handheld power tool 12, in particular a drill, is attached to the tool guidance element 42 via a friction-locking connection.

What is claimed is:

1. A suction adapter device for a handheld power tool that includes a suction head unit for direct application to a workpiece, the suction head unit comprising:
a tool guidance area configured to bound a through-hole recess for receiving and guiding a tool;
a workpiece support element located adjacent to the tool guidance area for application to the workpiece;
a main intake port configured to suction a main suction air flow;
a suction connector configured to connect to a suction hose;
a suction air duct extending from a main suction opening to the suction connector to guide a suction air flow, the suction air duct including a dust carrying section in which the suction air duct extends about the through-hole recess and is open in the direction of the through-hole recess; and
a secondary intake port configured to suction a secondary suction air flow that ends at one end of the dust carrying section or behind the dust carrying section in the suction air duct.

2. The suction adapter device of claim 1, wherein the tool guidance area defines a tool guidance axis, and wherein the secondary intake port is disposed circumferentially about the tool guidance axis substantially offset from the main suction opening.

3. The suction adapter device of claim 2, wherein the secondary intake port is disposed circumferentially about the tool guidance axis offset by at least 70° from the main intake port.

4. The suction adapter device of claim 1, wherein at least 10% of a total suction air flow is drawn in via the secondary intake port.

5. The suction adapter device of claim 1, wherein the tool guidance area defines a tool guidance axis, and wherein the suction air duct extends circumferentially about the tool guidance axis over an angular range of at least 180° about the tool guidance axis.

6. The suction adapter device of claim 1, wherein the suction air duct is at least partially bounded in operation by a workpiece.

7. The suction adapter device of claim 1, wherein the suction head unit further comprises a housing that is configured to at least partially form the tool guidance area and the workpiece support element.

8. The suction adapter device of claim 7, wherein the main intake port and the secondary intake port are formed integrally with the housing.

9. The suction adapter device of claim 1, wherein the suction head unit comprises a tool guidance element, which is at least partially pivotably supported, and is configured to directly abut a tool.

10. A handheld power tool system, comprising:
a handheld power tool; and
a suction adapter device according to claim 1.

11. The suction adapter device of claim 1, wherein the handheld power tool is a portable drill.

12. The suction adapter device of claim 1, wherein the suction connector is configured to releasably connect to the suction hose.

13. The suction adapter device of claim 2, wherein the secondary intake port is disposed circumferentially about the tool guidance axis offset by at least 90° from the main intake port.

14. The suction adapter device of claim 9, wherein the tool is a drill.

15. The handheld power tool system according to claim 10, wherein the handheld power tool is a drill.
